(19) United States
(12) Patent Application Publication
(10) Pub. No.: US 2023/0410080 A1
(43) Pub. Date: Dec. 21, 2023

(54) SYSTEM AND METHOD FOR SECURING INFORMATION IN A NETWORK

(71) Applicant: MASTERCARD INTERNATIONAL INCORPORATED, Purchase, NY (US)

(72) Inventors: Irina Singh, Chappaqua, NY (US); Shanthan Subramaniam, Baldwin Place, NY (US); Suman Rausaria, Chesterfield, MO (US)

(73) Assignee: MASTERCARD INTERNATIONAL INCORPORATED, Purchase, NY (US)

(21) Appl. No.: 17/843,559

(22) Filed: Jun. 17, 2022

(51) Int. Cl. G06Q 20/24; G06Q 20/38; G06Q 40/02; G06Q 20/20

(52) U.S. Cl. CPC G06Q 20/24; G06Q 20/385; G06Q 40/025; G06Q 20/202

(57) ABSTRACT

A payment management system and method of managing a payment network includes generating a payment token based on a bank account of a user (e.g., a buyer), receiving a dynamic code through a network for a transaction, and validating a request for payment of the transaction using an installment plan based on funds from the bank account. The validating the request for payment of the transaction is performed based on operations which include authenticating the payment token and verifying the dynamic code. In addition, the method includes generating a decision signal indicating a decision for the request when the request for payment is validated and transmitting the decision signal to a merchant system to authorize or decline completion of the transaction.

### FIELD

One or more embodiments described herein relate to securing information in a network (e.g., a payment network).

### BACKGROUND

Consumers have a variety of options they can use to pay for goods. One option is an installment plan offered by a merchant. An installment plan allows a buyer to take out a loan with the retail store instead of paying at the time of purchase. Usually, this involves the retail store reviewing the credit of the buyer and then approving the installment plan if the credit check meets certain requirements. Once approved, the buyer agrees to pay the retail store in incremental payments (or installments) over the period of the loan.

In this traditional payment model, the merchant makes the loan to the buyer. This forces the buyer to abide by requirements set by the merchant, which may be burdensome and onerous for the buyer to abide by. The merchant is also subject to risk if the buyer defaults on the loan. Moreover, the potential for privacy breaches and the failure to implement proper encryption and security to protect the integrity of the transaction exposes all parties to further risk.

### SUMMARY

Embodiments described herein include a system and method for implementing security measures to obtain and manage an installment plan approved to pay for goods or services from a merchant, where the installment plan is provided by a bank of the buyer and secured at the time of purchase.

An aspect of the present disclosure is drawn to a payment management system for use with a buyer, a merchant system, and a bank. The merchant system is configured to provide a good or service to the buyer and to generate a request of available banks. The bank is configured to establish a bank account for the buyer, to register with the payment management system, to provide a tokenized personal account number associated with the bank account to the payment management system, and to provide an available installment plan to the payment management system for the merchant system. The merchant system is additionally configured to provide the available installment plan to the buyer and to generate an installment plan selection including bank account information of the bank account for the buyer. The payment management system includes: a memory configured to store instructions; and a controller configured to execute the instructions to: register the bank; receive the available installment plan from the bank; receive the request of available banks from the merchant system; validate the request; provide the available installment plan to the merchant system based on a validation of the request; receive the installment plan selection from the merchant system; and provide the installment plan selection to the bank.

In some embodiments of this aspect, the installment plan selection includes a payment token associated with a primary account number (PAN) of the bank account. In some of these embodiments, the payment token is based on a card security code.

In some other of these embodiments of this aspect, the installment plan selection includes dynamic expiry data indicating a period of validity of the payment token. In some of these embodiments, the controller is configured to execute the instructions to: determine that at least one of the payment token or the dynamic expiry data is invalid; and cause transmission of a signal to the merchant system declining the request.

In some embodiments of this aspect, the payment management system is for further use with the bank being additionally configured to provide an installment plan approval based on the installment plan selection and the bank account, wherein the controller is configured to execute the instructions to additionally: receive the installment plan approval; and provide the installment plan approval to the merchant system.

Another aspect of the present disclosure is drawn to a method of using a payment management system with a buyer, a merchant system, and a bank. The merchant system is configured to provide a good or service to the buyer and to generate a request of available banks. The bank is configured to establish a bank account for the buyer, to register with the payment management system, to provide a tokenized personal account number associated with the bank account to the payment management system, and to provide an available installment plan to the payment management system for the merchant system. The merchant system is additionally configured to provide the available installment plan to the buyer and to generate an installment plan selection including bank account information of the bank account for the buyer. The method includes: registering, via a controller configured to execute instructions stored on a memory, the bank; receiving, via the controller, the available installment plan from the bank; receiving, via the controller, the request of available banks from the merchant system; validating, via the controller, the request; providing, via the controller, the available installment plan to the merchant system based on a validation of the request; receiving, via the controller, the installment plan selection from the merchant system; and providing, via the controller, the installment plan selection to the bank.

In some embodiments of this aspect, the installment plan selection includes a payment token associated with a primary account number (PAN) of the bank account. In some of these embodiments, the payment token is based on a card security code.

In some other of these embodiments of this aspect, the installment plan selection includes dynamic expiry data indicating a period of validity of the payment token. In some of these embodiments, the method further includes: determining, via the controller, that at least one of the payment token or the dynamic expiry data is invalid; and causing, via the controller, transmission of a signal to the merchant system declining the request.

In some embodiments of this aspect, the method is for further use with the bank being additionally configured to provide an installment plan approval based on the installment plan selection and the bank account, wherein the method further includes: receiving, via the controller, the installment plan approval; and providing, via the controller, the installment plan approval to the merchant system.

Another aspect of the present disclosure is drawn to a non-transitory, computer-readable media having computer-readable instructions stored thereon. The computer-readable instructions are capable of being read by a payment management system for use with a buyer, a merchant system, and a bank. The merchant system is configured to provide a good or service to the buyer and to generate a request of available banks. The bank is configured to establish a bank account for the buyer, to register with the payment management system, to provide a tokenized personal account number associated with the bank account to the payment management system, and to provide an available installment plan to the payment management system for the merchant system. The merchant system is additionally configured to provide the available installment plan to the buyer and to generate an installment plan selection including bank account information of the bank account for the buyer. The computer-readable instructions are capable of instructing the payment management system to perform the method including: registering, via a controller configured to execute instructions stored on a memory, the bank; receiving, via the controller, the available installment plan from the bank; receiving, via the controller, the request of available banks from the merchant system; validating, via the controller, the request; providing, via the controller, the available installment plan to the merchant system based on a validation of the request; receiving, via the controller, the installment plan selection from the merchant system; and providing, via the controller, the installment plan selection to the bank.

In some embodiments of this aspect, the installment plan selection includes a payment token associated with a primary account number (PAN) of the bank account. In some of these embodiments, the payment token is based on a card security code.

In some other of these embodiments of this aspect, the installment plan selection includes dynamic expiry data indicating a period of validity of the payment token. In some of these embodiments, the computer-readable instructions are capable of instructing the payment management system to perform the method further including: determining, via the controller, that at least one of the payment token or the dynamic expiry data is invalid; and causing, via the controller, transmission of a signal to the merchant system declining the request.

In some embodiments of this aspect, the non-transitory, computer-readable media is for further use with the bank being additionally configured to provide an installment plan approval based on the installment plan selection and the bank account, wherein the computer-readable instructions are capable of instructing the payment management system to perform the method further including: receiving, via the controller, the installment plan approval; and providing, via the controller, the installment plan approval to the merchant system.

### BRIEF DESCRIPTION OF THE DRAWINGS

FIG. 1 shows an example of one type of transaction.

FIG. 2A shows an embodiment of onboarding a bank to a payment management system.

FIG. 2B shows an embodiment of registration of installment plans to a payment management system.

FIG. 2C shows an embodiment of securing and completing a transaction based on an installment plan from a bank.

FIG. 3 shows an exemplary embodiment of a payment management system.

FIG. 4 shows an exemplary embodiment including a point-of-sale terminal screen.

FIG. 5 shows an interface related to one or more transactions according to an exemplary embodiment.

FIG. 6 illustrates a process in an embodiment of a method for implementing security measures.

### DETAILED DESCRIPTION

Conventionally, installments are offered on credit cards. Many retail stores offer installment programs and other Buy Now Pay Later (BNPL) programs on their private label store cards. There is no installment experience offered when a purchase is made using bank account.

There is no solution that offers secure installments at the POS and ecommerce checkouts on account-based purchases for any card scheme.

Further, fraudsters are using fake Ids (IDs that are stolen or fabricated) along with stolen information to create a synthetic id. Synthetic Id Fraud accounts for 20% of all chargebacks today. Bad actors are able to open BNPL accounts using a stolen card. In BNPL, the speed of an approval decision by an issuing bank associated with the retail store means that the “synthetic ID” has to be approved very quickly. Since the actual payment by the consumer is delayed, the actual consumer, who is unknowingly stuck with the bill, may not notice the fraud until weeks and sometimes months later. This fraud is rampant in BNPL today.

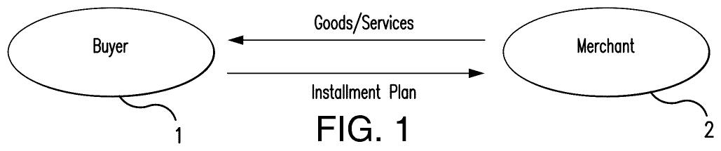

FIG. 1A shows one method of obtaining an installment plan for the purchase of goods or services. According to this method, a buyer 1 agrees to an installment plan offered by a merchant 2 to purchase the goods or services. The merchant 2 then extends a loan to the buyer 1 to be paid in incremental payments over time, with interest and fees. Thus, the loan is made directly between the buyer 1 and merchant 2 in an unsecured manner based on a loan commitment.

A system and method in accordance with aspects of the present disclosure provides a mechanism by which secure installments can be provided on bank accounts at a point of sale.

A system and method in accordance with aspects of the present disclosure provides an installment experience to customers using bank accounts to pay at a POS, for in store purchases, and ecommerce purchases. This solution contains no changes to the POS and no changes to the acquirer systems. A consumer is prompted at merchant check out (for both ecommerce or instore) to pay in installments when using a bank account for payment.

Further, a system and method in accordance with aspects of the present disclosure is secured using a token and an associated cryptogram data when making purchases with installments.

Still further, with a system and method in accordance with aspects of the present disclosure, the consumer's financial institution (CFI—the consumer's bank being referred as CFI) verifies the consumer and their bank account and processes a loan account after proper validation, thus minimizing the synthetic id fraud. In this case, the risk of synthetic id fraud is relatively minimal since the CFI validates the consumer and the bank account prior to making a decision.

Still even further, a system and method in accordance with aspects of the present disclosure can be delivered on the Domestic Real time payment network to clear and settle in real time, or it can be used to clear and settle on any Card Scheme such as Mastercard. This solution is multi-rail, and is therefore unique.

Additionally, a system and method in accordance with aspects of the present disclosure offers an installment market place for providing streamlined installment plans to the shopper—the Original Equipment manufacturer (OEM) can provide installment plans, the merchant or the BNPL provider can provide installment plans or the issuer can provide installment plans. This solution caters to all the plans provided by any third party.

A system and method in accordance with aspects of the present disclosure provides benefits to financial services corporations, such as for example Mastercard. For example, a system and method in accordance with aspects of the present disclosure: enables quick Go To Market for the financial services corporation for an installment service; and provides a secure installment experience to the issuing banks so that issuing banks can offer BNPL plans to their consumers (Debtors) for purchases made using bank accounts.

A system and method in accordance with aspects of the present disclosure provides benefits to banks, both issuing banks and acquiring banks. For example, a system and method in accordance with aspects of the present disclosure: lowers cost by simplifying the transaction flow for the banks by using standard APIs without the use of additional infrastructure such as gateways; eliminates a requirement for a processor by the issuing bank; and banks to offer more payment choices to their consumers and increases the engagement with their own consumer (debtor).

A system and method in accordance with aspects of the present disclosure provides benefits to merchants. More specifically, the system and method benefits merchants who have had a decline in consumers given the current global pandemic. Merchants can also receive funds in real time since this solution can be settled on the real time payment network available in the country (example TCH in US).

A system and method in accordance with aspects of the present disclosure provides benefits to the consumer. In particular, with COVID, many consumers have shifted to making purchases online. In accordance with aspects of the present disclosure, a consumer is able to purchase more expensive items without paying the full amount at the time of purchase.

A system and method of providing a secure installment plan at a point of sale from a user's bank account in accordance with aspects of the present disclosure can include three stages. The first stage being onboarding, the second stage being an installment plan registration, and the third stage being drawn to the APIs and the transaction flow.

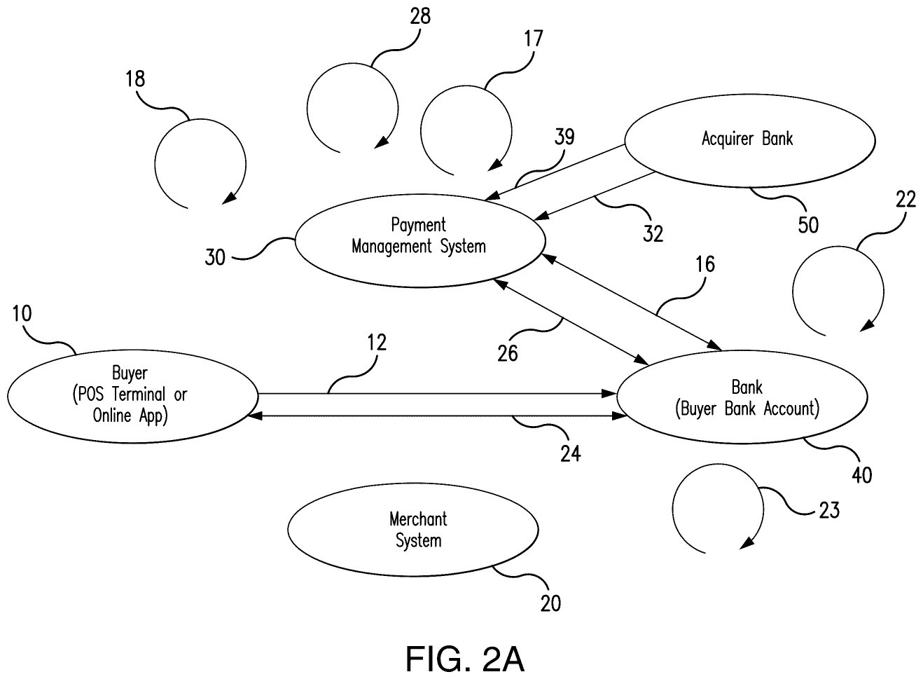

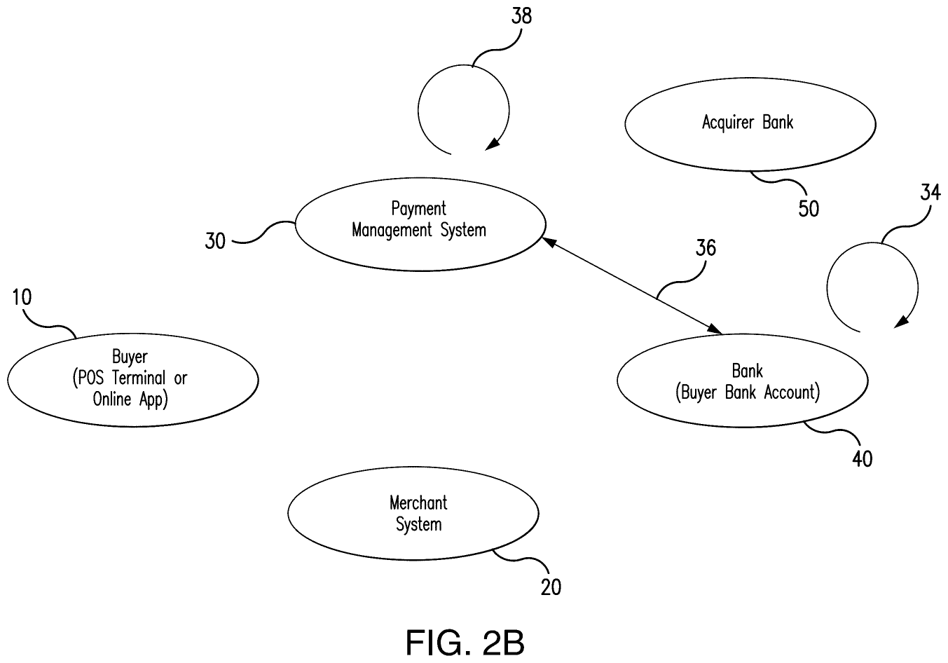

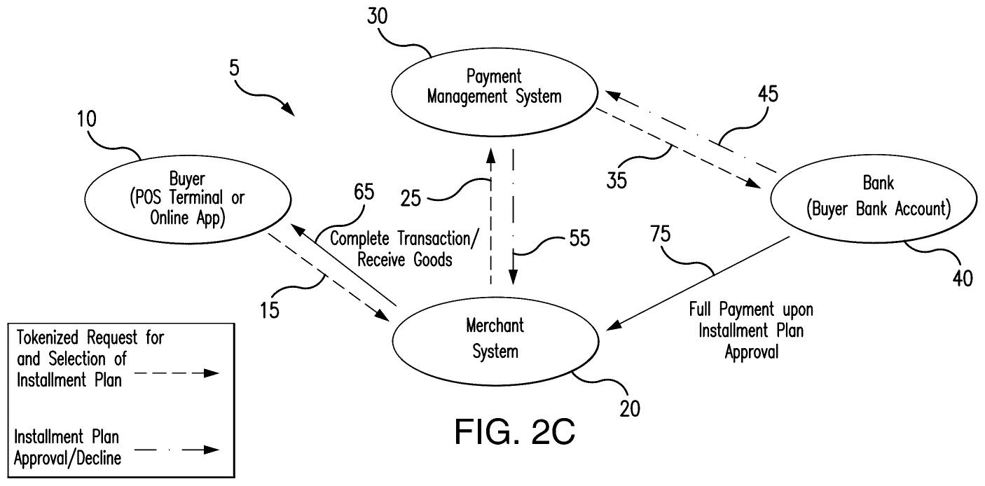

The first stage, onboarding, will be described in greater detail with reference to FIG. 2A. As shown in the figure, initially, a buyer 10 opens an account at a bank 40 as shown at 12. Subsequently, the payment management system 30 registers a plurality of consumer financial institutions (CFIs), including the bank 40, as shown at 17. After registration, the payment management system 30 assigns a unique identifier to every CFI, respectively, and registers every CFI with their respective national transit number, as shown at 18. Accordingly, the bank 40 can be uniquely identified within a country.

Each CFI registers their consumers with a respective CFI-provided unique consumer ID. For example, the bank 40 registers the buyer 10 with a CIF-provided unique consumer ID, as shown at 22. A consumer ID identifies the buyer 10 uniquely to the bank 40. Thus, a consumer ID is unique within the bank 40 and is used by the bank 40 to identify (and optionally authenticate) their consumer. Once buyer 10 is registered using their consumer ID, the bank account number of buyer 10 at bank 40 is tokenized, as shown at 23, using tokenization services of a Primary Account Number (PAN) to generate a token PAN. Tokenizing a bank account number to a corresponding token PAN provides an additionally level of security when providing a secure installment plan at a point of sale from the bank account of the buyer 10 at the bank 40.

The bank 40, for example via a mobile application running on a client device or through a website application, provides an experience for the buyer 10 to accept the Terms and Conditions, as shown at 24. The application of the bank 40, as running on a client device or through a website, also provides a button, which when clicked shows the token PAN and contacts the payment management system 30 to get a dynamic expiry and a card security code such as a CSC, as shown at 26.

A card security code (CSC; also known by several other names, such a CVC2 by MasterCard) is a series of numbers that, in addition to the bank card number, is embossed or printed on a card. The CSC is used as a security feature for card not present transactions, where a personal identification number (PIN) cannot be manually entered by the cardholder (as they would during point-of-sale or card present transactions). It was instituted to reduce the incidence of credit card fraud.

Tokenization is a generalized concept of a cryptographic hash. A cryptographic hash, or cryptographic hash function, is an algorithm that takes an arbitrary amount of data input—a credential—and produces a fixed-size output of enciphered text called a hash value, or just a “hash.” That enciphered text can then be stored instead of the password itself, and later used to verify the user It means representing something by a symbol (‘token’).

For instance, a bank account number represents a user's bank account. In the context of cryptography, a token is a symbol (or a group of symbols) that represents some sort of confidential information. It is done in such a way that no useful information is leaked when it is represented by its token. A cryptographic token is usually (but not always) the same as a cryptographic hash, a one-way function with the smallest probability that two different pieces of information have the same token representation.

In the banking industry, the Payment Card Industry Data Security Standard (PCI-DSS) requirements usually command or recommend that credit card information, which is sensitive by nature, is tokenized or encrypted when stored in databases. In the banking industry, tokenization has great importance. For instance, the PAN (Primary Account Number) is not to be exposed in databases. Therefore, a token PAN is usually substituted to represent the PAN. For example, the following dictionary shows a conversion between some MasterCard PANs and tokens:

| | |
|---|---|
| MasterCard,4539694012170142 | 8mSaFDbNyBdAm8PVlj4mFmvz |
| MasterCard,4556495739549693 | 8MqXgbBU4xVfXmdz6GkMnGyf |
| MasterCard,492909084020546 | fRtNNwJEqF7JcSQjja73JTTy |
| MasterCard,4929745538911418 | KU6U3wtnfYE6P8v9SDLhat8s |
| MasterCard,4716198351731290 | mcuHJPawy9tEaK8JPh7YGAU5 |
| MasterCard,4929676462242391 | crk9X8KBDVHLjV985hDNM6Ry |
| MasterCard,4716480777748036 | kUEnrJTHq5YRNWqGDXpakK7v |
| MasterCard,4539159281288466 | J9SfcJW2gkyWMp92CQ47FnYT |
| MasterCard,4716611799749544 | 7xgq2MtMdkYujjG8TAKD3T4a |
| MasterCard,4929778514511728 | KYea5C9rL7FFJ9zE8dXYgVjK |

(etc...) (etc...)

Here, the tokens do not preserve the original formatting. Tokens have better usage when they respect the like-to-like format rule. For instance a 16 digit PAN should be represented by a 16 digit token.

After tokenization, there is a token PAN (16 digit Card pan) mapped to the bank account, along with a one-time use expiry and one time use CSC. Then a token PAN is generated by the payment management system 30 along with a dynamic card security code and dynamic expiry, as shown at 28. The dynamic expiry and card security code are dynamic for every transaction (i.e. unique for every transaction and are validated by the payment management system). The token PAN can also be used in contactless transactions in store using the mobile banking application running on a client device. This gives additional security to the transaction.

A participating acquirer 50, i.e., an acquiring bank, is registered with the payment management system 30 and is assigned a unique acquirer ID, as shown at 39. The acquirer 50 then registers, with the payment management system 30, their eligible merchants with a respective merchant name and location address, as shown at 32. The payment management system 30 then assigns each registered merchant with a unique merchant ID. In this example, merchant system 20 corresponds to a merchant that is registered with acquirer 50.

The second stage, installment plan registration, will be described in greater detail with reference to FIG. 2B. As shown in the figure, the bank 40 generates at least one installment plan the bank 40 will offer to customers, as shown in 34. The bank 40 registers any installment plans the bank 40 offers to customers with the payment management system 30. This registration may be performed for example via an application protocol interface (API). Every installment plan that the bank 40 registers, wherein each CFI is associated with a unique CFI ID as discussed above, may include at least one of the following information: a) the duration of the installment plan; b) interest or fees associated with the installment plan, if any; c) participating merchants for the installment plan; and d) combinations thereof.

Similarly, other third parties may register their respective installment plans. Non-limiting examples of such other third parties include: third party Buy Now Pay Later plan provider, original equipment manufacturers, merchant banks or acquirer banks. When these installment plans are registered, they are mapped to the banks that are eligible to offer them in accordance with aspects of the present disclosure.

After registration, the bank 40 provides registered installment plans to the payment management system 30, as shown at 36. The payment management system 30 then maps a unique installment plan ID to each installment plan, respectively, as shown at 38. The installment plan ID uniquely identifies the installment plan in the payment management system 30. These installment plan IDs are created after the onboarding of the bank 40.

The third stage, APIs and transaction flow, will be described in greater detail with reference to FIG. 2C. However, first a general discussion of the third stage will be provided.

With respect to the third stage, APIs and transaction flow, an acquirer bank or payment service provider (PSP) may use an API, for example at a POS terminal or at a website operated by the acquirer bank or PSP, to look up eligible installment plans. The acquirer bank or PSP may then provide a list of the eligible installment plans that to the consumer during checkout. The consumer can select their bank, for which they have an account, and is then presented with a list of available installment plans for the purchase.

The acquirer bank or PSP may then initiate a shadow balance check service. This service passes the following data from the acquirer bank or PSP to the payment management system: the payment token and the associated dynamic cryptogram; the consumer selected installment plan; the total transaction amount; the currency; the acquirer id; the category code; and the merchant name to the payment management system.

The payment management system then performs a security validation of the merchant acquirer using the acquirer id. The payment management system then validates the payment token and cryptogram and substantially mitigating (and possibly wholly eliminating) fraud. Once the payment token and the cryptogram are validated, the payment management system generates a universally unique identifier (UUID) for the transaction. The payment management system then passes this UUID to the acquirer bank or PSP in an acknowledgement (ACK). The payment management system then maps the token to consumer bank account and retrieves the unique consumer ID associated with the consumer bank account.

The payment management system then passes information in the shadow balance API to the CFI. Information in the shadow balance API can include: the UUID; the bank account number; the consumer ID; the merchant name; the selected installment plan; the transaction amount; the currency; the multi-currency conversion (MCC); and the acquirer ID.

The CFI performs a risk analysis of the consumer using the consumer ID and bank account associated with the consumer ID. Further, the CFI may send a onetime password (OTP) to the payment management system to authenticate the CFI.

The CFI then authorizes the transaction, sets up a loan account for the consumer for the selected installment plan, and responds back to the payment management system with an approval and a unique approval key. It should be noted that the CFI does not deduct the transaction amount from consumer's account. On the contrary, once the installment plan is set up by the CFI, the CFI can begin to perform the debit of the consumer's account in accordance with the selected installment plan.

The payment management system then passes the response from CFI back to the acquirer bank/PSP and the transaction is completed.

Clearing and settlement of the installment plan is business as usual (BAU) in the banking industry. In clearing, the acquirer submits clearing for the full transaction amount. Settlement takes place and the funds are moved from the CFI to the acquirer as BAU. Further, other providers may be added for additional installment plans, such as original equipment manufacturers.

FIG. 2C conceptually shows a method for securing transactions in a payment network 5 in accordance with one or more embodiments. The payment network 5 may include a buyer 10, a merchant system 20, a payment management system 30, and a bank 40. The payment management system 30 may secure and manage the flow of information in the network in order to allow the buyer 10 to purchase goods or services from the merchant based on an installment plan offered by the bank 40. Because the processing and operations performed by the payment management system 30 are implemented using multiple levels of encryption and other security measures, the integrity of the transaction and the privacy interests of the parties may be protected, all while allowing the buyer 10 to use a new form of payment in the form of an installment plan obtained from the buyer's bank 40 at the time of purchase.

Referring to FIG. 2C, the buyer 10 goes to a point-of-sale terminal at a store of the merchant or uses an application online (or on his smartphone or other device) to purchase goods or services. The buyer selects the payment option of using an installment plan at his or her bank to pay for the transaction, as shown at 15. The merchant system 20 (POS terminal or application) generates a payment request using the installment plan. The bank account number, of the bank account of the buyer 10, is mapped to a 16 digit token PAN and is accompanied with a one-time use cryptogram, or CSC and a one-time use expiry associated with the 16-digit token PAN. The merchant system 20 sends, as shown at 25, an authorization request that includes the token PAN, the CSC, and the expiry to the payment management system 30. The payment management system 30 verifies the PAN, the CSC and expiry. Verification is performed as discussed above with reference to step 1—onboarding. The token PAN may be accompanied by one or more forms of dynamic code (e.g., a dynamic CSC value) and/or other information included in a cryptogram.

The payment management system 30 may validate the request and the merchant system 30 (and in some embodiments an intermediary such as an acquirer) based on pre-assigned and optionally encrypted identifiers. Once validated based on the digital payment token and CSC, the payment management system 30 may send the request with details of the transaction and other information 35 to the bank 40 of the buyer, who maintains at least one account with the bank 40. Information 35 may be sent to the bank 40 using additional security measures including, but not limited to, a transaction-specific identifier.

The bank (e.g., a bank software system) 40 may perform a risk analysis and render a decision concerning whether to approve or decline the installment plan for the purchase. The bank 40 may then send information 45 including the decision and the transaction identifier (and/or other information) to the payment management system 30, which authenticates and verifies the information. The payment management system 30 then sends a secured message to the merchant system 20 with the decision, as shown at 55. If the installment plan is approved by the bank 40, the buyer is notified, and the transaction is completed 65. The bank 40 then transfers the full payment 75 for the transaction to the merchant system 20 or the bank of the merchant using normal clearing and settlement procedures. On the other hand, if the installment plan is declined, the buyer is informed of the same by the merchant system 20. (As used herein, use of the term “bank” may include both a bank and a credit union).

The payment management system 30 implements the security measures and manages the process to allow real-time payment by bank-provided installment plan at the time of the transaction. The process is performed in a very short period of time, in some cases thirty seconds or less, thus making the system and method embodiments appropriate for real-time use.

During this process, the buyer may be physically present at a store (e.g., point-of-sale terminal) of the merchant or may be using an online shopping cart or other payment application on webpage to make the purchase online. If the purchase-by-installment plan is approved, the bank may authorize the installment plan, send payment to the retailer at a designated time (e.g., indicated by 75 in FIG. 2C), and the buyer may receive the goods or services, either immediately or the goods may be sent by mail or a shipping arrangement. Under the terms of the installment plan, the bank 40 may access funds from the bank account of the buyer to receive incremental payments over the period of the loan. The funds may be received by the bank 40, for example, automatically through monthly or other periodic debits of the account or the buyer may retain the right to manually authorize the installment payments.

Through these embodiments, the merchant is assured of being paid in full at the time of purchase (subject to clearing and settlement) and the buyer is assured the convenience and security of using his bank account to pay for goods or services using an installment plan. As used herein, the installment plan may include a buy-now, pay-later plan or any other type of delayed payment plan using a bank account. For example, in accordance with one or more embodiments an installment plan may include any plan in which the buyer makes one or more payments to a bank to pay off a bank loan using funds in at least one bank account, where the one or more payments are made after purchase of the goods or services in increments over time or by a lump-sum payment.

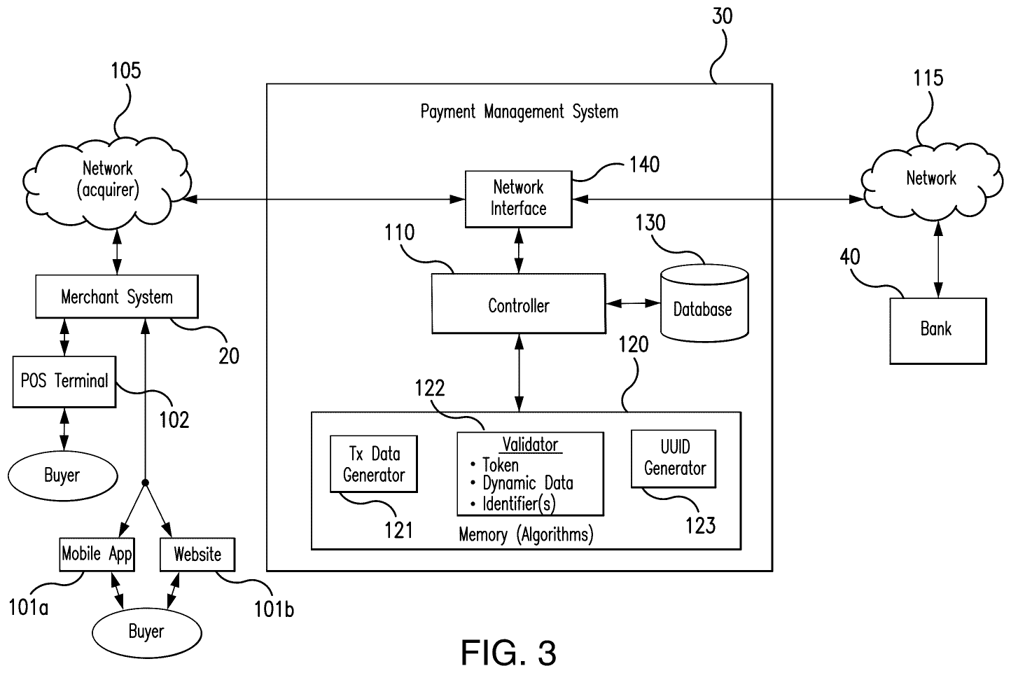

FIG. 3 shows an embodiment of the payment management system 30 for managing and securing transactions that allow a buyer to select payment of goods or services using an installment plan provided by his or her bank at the time of purchase. The system 30 may be implemented, for example, on a server situated along a network path between the merchant system 20 and the bank 40 of the buyer in a payment network, e.g., network 105. The server may be located at a payment processor, an acquirer system, or another location in the payment network such as shown in FIG. 2C. In some embodiments, the server may be located at the bank, the merchant system, or another location involved, directly or indirectly, with the associated transaction.

Referring to FIG. 3, the system 30 includes a controller 110, a memory 120, a storage area 130, and a network interface 140. The controller 110 may be implemented, for example, by one or more processors that execute instructions stored in the memory 120, which instructions may perform operations of the embodiments described herein. For example, memory 120 may store instructions (including, but not limited to, one or more algorithms) for implementing at least a transaction (Tx) data generator 121, a validator 122, and a unique identifier generator 123. For example, when executed, the instructions cause the controller 110 to authenticate a buyer, validate a bank account of the buyer, perform payment token and dynamic code validation, generate and verify identifiers corresponding to the transaction, generate transaction data and decision signals based on installment plan requests, and perform other operations such as, but not limited to, those relating to managing and securing transaction-related communications between the bank and merchant system (and optionally any intermediaries) using encryption and other security measures.

In some embodiments, as will be described in greater detail below, the controller 110 is configured to execute instructions in memory 120 to: register the bank 40; receive an available installment plan from the bank 40; receive a request of available banks from the merchant system 20; validate the request of available banks; provide the available installment plan to the merchant system 20 based on a validation of the request; receive the installment plan selection from the merchant system 20; and provide the installment plan selection to the bank 40.

In some embodiments, as will be described in greater detail below, the installment plan selection includes a payment token associated with a primary account number (PAN) of the bank account of the buyer 10 at the bank 40. In some these embodiments, as will be described in greater detail below, the payment token is based on a card security code. In other of these embodiments, as will be described in greater detail below, the installment plan selection includes dynamic expiry data indicating a period of validity of the payment token. In some of these embodiments, as will be described in greater detail below, the controller 110 is configured to execute instructions in memory 120 to: determine that at least one of the payment token or the dynamic expiry data is invalid; and cause transmission of a signal to the merchant system 20 declining the request of available banks.

In some embodiments, as will be described in greater detail below, the controller 110 is configured to execute instructions in memory 120 to: receive an installment plan approval; and provide the installment plan approval to the merchant system 20.

The storage area 130 (e.g., a database) may store data and all information received through the network interface 140 and generated by the processing operations of the controller 110 for implementing the operations and embodiments described herein. For example, the storage area 130 may store the name and account information of buyers who have enrolled or subscribed to the payment management system, information of banks which have elected to participate in extending installment plan payments to account holders with respect to their purchases, payment tokens and dynamic codes generated for the buyer's bank account and/or other buyer-related information, identifiers and other information corresponding to the merchant system, the banks, and intermediaries (if any), authentication and validation information which may be used to secure the transaction and associated installment plan requests, as well as other information.

The network interface 140 controls the communication of signals received by and transmitted from the payment management system 30. In one example implementation, the payment management system 30 may be coupled between the first network 105 and a second network 115. The first network 105 may communicate information, directly or indirectly, between the payment management system 30 and a merchant system 20. If indirectly, the payment management system 30 may transmit/receive information to/from the merchant system 20 through an acquirer system situated along network 105. The acquirer system may be, for example, a bank of the merchant maintaining the merchant system 20.

The merchant system 20 may be connected to a point-of-sale (POS) terminal 102 in the event the buyer is making the purchase at a retail store. To support online purchases, the merchant system 20 may communicate with (or be otherwise linked to) an application 101 a installed on a device of the buyer or a website 101 b hosted by the merchant system 20.

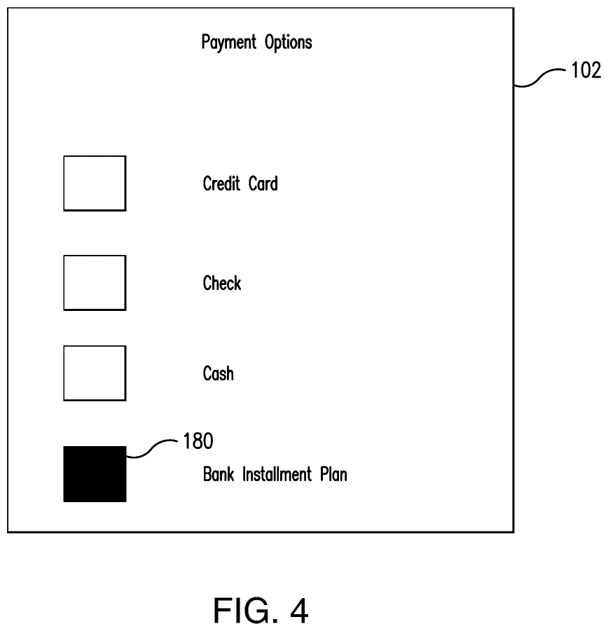

The POS terminal 102 may be implemented in various ways, for example, at the preference of the merchant or based on the design of the terminal. In addition to the traditional forms of payment, in one embodiment the POS terminal 102 may be programmed to provide the buyer with the option of requesting payment by installment plan using the funds in a bank account. For example, as shown in the example of FIG. 4, the POS software may provide a menu option 180 displayed on the POS terminal 102 that allows the buyer to select payment by bank installment plan.

Once selected, processing may take place in a variety of ways. For example, selection of menu option 180 initiation generation of a request by the merchant system 20 for a list of banks that participate with the payment management system in making installment-plan purchases. The buyer may then select a bank and enter digital security data and other information pursuant to the transaction. For example, the digital security data and information may identify the selected bank and bank account (e.g., bank account type, account number, etc.).

In one embodiment, the buyer may manually enter this information into the POS terminal 102. In this case, information linked to the token PAN, the dynamic codes and/or other account-related information may be received in a text, an email, or a call to the payment management system or bank. In other embodiments, this information may be retrieved from the merchant system 20.

Once the data is received, the POS terminal 102 may transmit the payment token (with the bank account encoded therein), a cryptogram bearing the dynamic code, identifiers and other information relating to the transaction, to the payment management system 30. The payment management system 30 then responds with a decision concerning whether the buyer was approved for payment via bank installment plan based on a risk analysis performed by the bank 40. Operations may be performed in real-time at the POS terminal 102 and/or payment management system 30. Because the purchase is conditioned upon installment plan approval, the merchant and bank are protected from fraud (e.g., vis-à-vis synthetic ID or by other techniques) which could otherwise occur if the payment management system were not used to protect and process the purchase.

As previously described, the purchase may also occur online, for example, through application 101a on a network-connected device or through a website 101b. The network-connected device may be a smartphone, tablet or notebook computer of the buyer. The device may include an application program interface (API) which allows the buyer terminal to interact (e.g., through merchant system 20) with the payment management system 30 and submit installment plan requests and processing as described herein. In one embodiment, the device may access the website 101b such as in the case of the notebook computer using an internet browser.

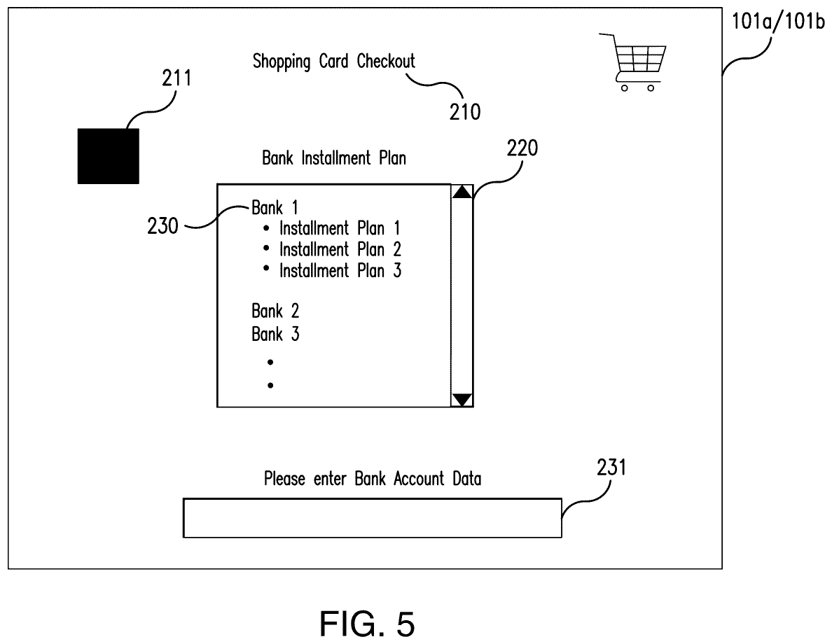

When an API is used, the API may operate with, or be implemented in the code of, an application or website of the merchant system 20. For example, as shown in FIG. 5, the software of the merchant application or website 101a/101b may include a shopping cart feature 210 which stores information corresponding to a product a buyer has selected for purchase online. The shopping cart software may be modified to provide a menu selection 211 that allows a buyer to select payment by bank installment plan. Once selected, information may be displayed (e.g., in the form of a drop-down menu 220) showing a list of banks 230 participating with the payment management system for installment-plan purchases. The buyer may scroll through the list in the drop-down menu to locate his/her bank and make a selection. After the selection is made, the buyer may be requested to provide information 231 identifying his/her bank and/or bank account (e.g., bank account type, account number, etc.). This information may include the token PAN (or other tokenized version of the bank account) and optionally the dynamic code.

The token and data may be entered in accordance with any of the methods described herein. Once this information and data is entered, the application 101a or website 101b may send the information to the payment management system 30 (via merchant system 20), along with transaction and other information as described herein, using cryptogram.

In one embodiment, one or more elements of network 105 may be located between the payment management system 30 and the merchant system 20. The network elements may include, for example, a gateway server and/or an acquirer system or payment server provider (PSP) system. These network elements may be referred to as intermediaries, or intermediary systems, in the following description.

The second network 115 may be coupled between the payment management system 30 and the servers of one or more banks, which have enrolled to participate in the installment plan purchase of goods and services through the payment management system. Information may be communicated between and among the buyers, banks, and the payment management system 30 (in some cases, through one or more intermediaries) to verify, validate, authenticate, and complete purchases through installment plans using bank account funds.

### Payment Management System Registration

In accordance with one or more embodiments, the buyer, the bank account of the buyer, the merchant system, and one or more intermediaries and other participants may register with the payment management system 30 for authentication and verification purposes. All or a portion of the network communications may be encrypted over, for example, a secure socket layer (SSL) for enhanced security purposes.

Banks seeking to participate with the payment management system 30 in approving installment-payment loans may register with the payment management system 30 in order to receive a unique identifier. Registration may be performed, for example, based on the national transit number of each bank, so that each bank may be uniquely identified within a country by the payment management system 30. Each bank may also register their customers (e.g., account holders), at least for ones who wish to participate in purchasing goods and service using an installment plan provided from the bank.

The bank may register their account holders (e.g., buyers), for example, by providing the payment management system 30 a unique customer identifier issued by the bank. Transactions submitted for approval of installment-plan payments may be performed based, in part, on the customer (or buyer) identifier. The customer identifier may also be used as a basis for the bank authenticating a buyer when a request for an installment-plan purchase is submitted for consideration and approval.

Once the buyers are registered using their identifiers, the bank account of each participating account holder may be tokenized using, for example, tokenization services to a primary account number (PAN). The tokenization process increases the security of the transaction information communicated with the payment management system, in a manner to be described in greater detail below.

The payment management system 30 may be configured to receive transaction-related information in a variety of ways. One way involves using a mobile banking application of the bank of the buyer. The mobile banking application may also provide a button which, when clicked, communicates with the payment management system 30 to receive a dynamic code and expiry information.

In accordance with one or more embodiments, the payment management system 30 may generate the token with a dynamic code and dynamic expiry information. As discussed below, this dynamic information may be uniquely generated for every transaction (e.g., may be unique for every transaction and may be validated by the payment management system 30). The token may also be used in contactless transactions in store using the mobile banking app. This gives additional security to the transaction.

In addition to the bank and bank customers, various intermediaries may be registered within the payment management system 30 and themselves assigned a unique identifier. The acquirers may be the banks of the merchants. These banks may register merchants who have agreed to accept payment for goods and services through a bank-provided installment plan. The registration information may include the merchant name and merchant location address (or store number), and or other information. Registered merchants are then assigned unique identifiers by the payment management system 30.

The payment management system 30 may also register the various types of installment plans being offered by participating banks. For example, each bank assigned a unique identifier by the payment management system 30 may register their one or more installment plans by indicting the duration of the installment plan, the interest rate and any associated fees, and participating merchants.

Additionally, in one embodiment, any third party may register their installment plans, including but not limited to third-party Buy Now Pay Later (BNPL) plan providers, Original Equipment Manufacturers (OEMs), or the merchant or the acquirer. When these plans are registered in the payment management system 30, they may be mapped to the banks that are eligible to offer them in the installment plan solution. After registration, the payment management system 30 may map every installment plan to an identifier, which, for example, uniquely identifies the installment plan in the system. These identifiers may be uploaded to the system, for example, after registration of the banks is performed.

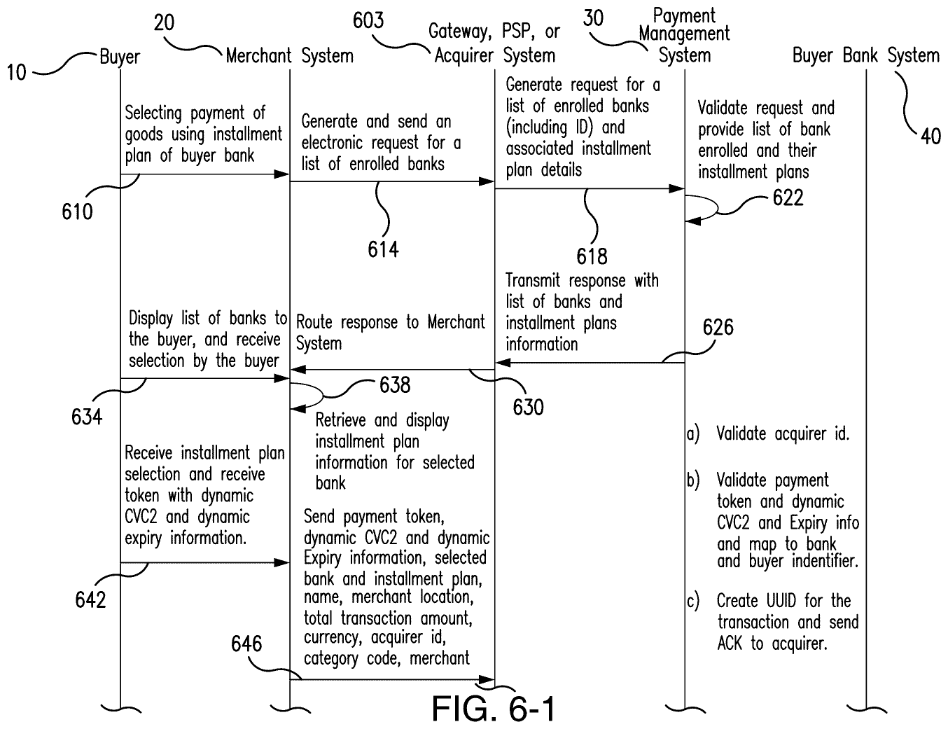

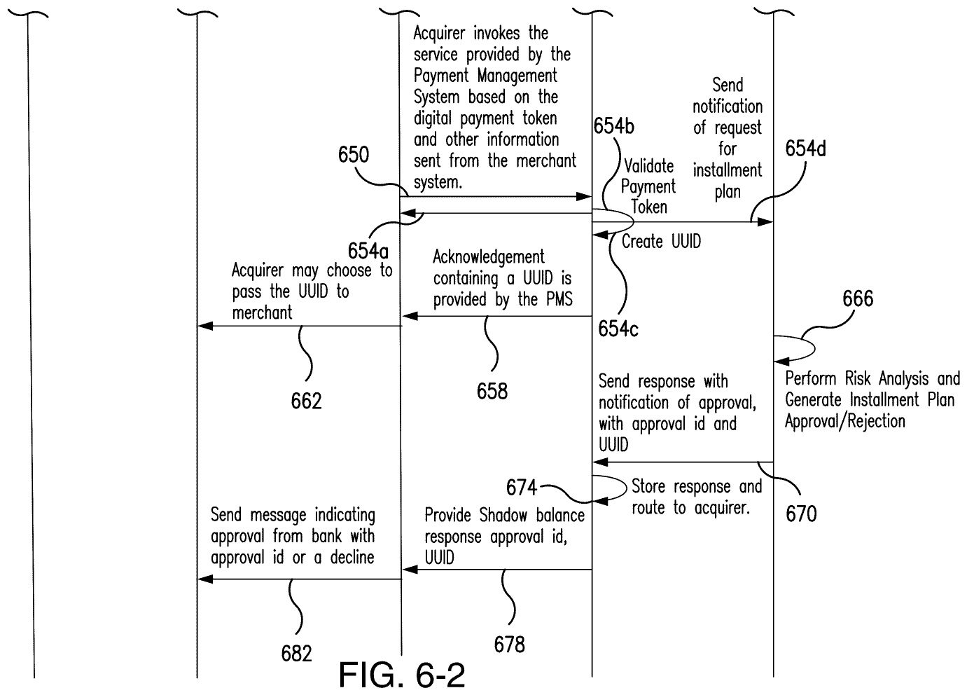

FIG. 6 shows operations included in an embodiment of a method for implementing security measures to allow a buyer to authorize and manage use of an installment plan to pay for goods or services based on funds from his bank account. The method may be implemented using any of the system embodiments described herein or a different system may be used.

The method is implemented, for example, based on a signal path that extends through a merchant system 20 which receives/outputs information from/to a buyer 10, an intermediary system 603, a payment management system 30, and a network of one or more banks 40. The merchant system 20 may be a POS terminal for supporting in-store purchases or a device application or website for supporting online purchases of goods and surfaces of the merchant, for example, as previously discussed. The intermediary system 603 may be a gateway server or processing system of an acquirer or PSP.

The bank 40 may include an account (e.g., checking account) which the buyer 10 has designated as installment-plan eligible. In other embodiments, the intermediary system 603 may be omitted and/or the payment management system 30 may be integrated into the merchant system 20 or a system of the bank. For illustrative purposes, the method will be explained to include intermediary system 603.

Referring to FIG. 6, the method includes, at 610, the merchant system 20 receives information from the buyer 10 selecting (or requesting) to pay for goods and/or services using an installment plan offered by a bank. When the purchase is made in a store of the merchant, the installment plan request may be generated based on a menu or other selection made by the buyer on a POS terminal as previously described. When the purchase is being performed online, the installment plan request may be generated based on menu or selection on a device application, website, or other ecommerce service provided by the merchant. For example, the installment plan request may be based on a payment option selected during checkout of a shopping cart made available on the merchant website or application. Examples are described above.

At 614, the merchant system 20 generates an electronic request based on the installment plan selection made by the buyer 10. The electronic request may include information requesting a list of participating banks enrolled in the installment plan program or otherwise participate with the payment management system 30. Once the request is generated, it may be sent by the merchant system 20 to the acquirer or other entity serving as the intermediary system 603. For purposes of illustration, the intermediary system 603 may be an acquirer system.

At 618, the acquirer system 603 generates a request to be sent to the payment management system 30 to retrieve the list of participating banks. In one embodiment, the request from the acquirer system 603 may be sent with additional information, including but not limited to acquirer identification (ID) information. The request may be sent without identifying the buyer at this point (e.g., the acquirer request may be buyer-agnostic) or may be sent with identification of the buyer and/or his bank. Sending the identification information may help to reduce sending back a very large list of banks to the merchant terminal.

At 622, the payment management system 30 may validate the request sent from the intermediary system (e.g., acquirer) 603. Validation may be performed in a variety of ways. In one embodiment, the request may be validated by determining whether the request was sent from an acquirer (or other intermediary) who previously registered with the payment management system 30. For example, as a pre-requisite to participating with the payment management system 30, each acquirer may complete a registration process in order to receive a unique identifier. When the request is received from the acquirer 603, a search may be performed by the controller of the payment management system 30 to confirm whether the acquirer identifier in the request matches an acquirer identifier stored in a database. The request may be validated or rejected based on the result of the database search.

Once the request has been validated, the payment management system 30 may generate (or otherwise access) a list of participating banks that have enrolled in the installment plan payment option. In one embodiment, this may be accomplished by searching information stored in a database of payment management system 30 (e.g., in 130) to obtain a current list of the enrolled banks. The database may also store detailed information of the various installment plans that are offered. Some banks may only provide one installment plan, while others may offer other types of plans. The plans may differ, for example, based on interest rates, payment terms, payment frequencies, fees, conditional payment any pay-off options, and/or other features relating to the loans to be extended.

At 626, once this list is generated, the payment management system 30 may send a response to the request received from the acquirer system 603. The response may include the list of banks and their installment plan information. The request may be sent along a signal path that leads back to the customer. In one embodiment, this signal path may pass back through the intermediary (e.g., acquirer) 603 or may pass along a different signal path.

At 630, the acquirer (or other intermediary) 603 may route the response back to the merchant system 20 (if the sale is being considered at a POS terminal at a retail store) or the merchant website where an online purchase is being sought by the customer. The routing may be performed, for example, based on destination information (e.g., a network address) included in packets carrying the information of the request. The destination information may correspond, for example, to sender information (e.g., a network address) of the merchant system 20.

At 634, the merchant system 20 displays (or otherwise presents) to the buyer 10 the list of banks generated by the payment management system 30. This may be accomplished in a variety of ways. For example, the list of banks may be presented as a scrolling list of banks on the POS terminal or shopping cart checkout application. Presentation of a scrolling list allows the consumer to scroll through the list to determine which banks are offering payment by installment plan. The merchant system 20 may then receive information identifying a selection of a bank from the list with which the buyer 10 has an account. The selection may be made by a cursor, mouse pointer, stylus pen, or other information input technique used by the buyer 10.

At 638, the merchant system 20 displays information describing the one or more installment plans offered by the selected bank, which information was included in the response sent from the payment management system 30. The information may be displayed, for example, in a new screen on the POS terminal or shopping cart application or in any one of a variety of other ways. The displayed information allows the buyer 10 to review the features and terms of the loan(s) of the installment plan(s) and make a decision whether he or she wants to go forward with payment under the (or one of the) offered plan(s).

At 642, the buyer 10 selects the installment plan to be used to pay for the goods or services. The buyer 10 may also be queried for additional information. The additional information may include information corresponding to a digital token to be generated for securing (e.g., authenticating and verifying) the transaction. In one embodiment, the digital token may include a dynamic code which may or may not be accompanied by dynamic expiry information. This information may be entered by the buyer 10 by way of a POS terminal at the retail store or may manually enter the information (e.g., card number, dynamic CSC, and/or dynamic expiry information) into the shopping cart application.

In other embodiments, the queried information may be input in other ways. Examples include various forms of contactless entry using a mobile banking application or digital wallet on the buyer's device or a mobile payment application on the buyer's device that is linked to bank account number of the buyer's bank. Each of these applications may generate dynamic codes with or without dynamic expiry information to be uniquely used for each transaction presented for installment plan authorization and payment. Once the dynamic information (e.g., dynamic code and expiry information) is generated, a cryptogram may be generated to include this information. The cryptogram may be sent with the payment token to the payment management system.

In one implementation, the aforementioned applications or online shopping cart may provide a button which, when clicked by the buyer, shows the PAN associated with the token PAN. This button may also automatically contact the payment management system 30 (e.g., via call, text, online communication, etc.) in order to obtain the dynamic code (e.g., CSC) and dynamic expiry information.

Thus, through this technique, multiple levels of security are taken to protect the transaction and the payment information used when purchasing a product using a bank provided installment plan provided at the point of sale or other time of transaction. For purposes of illustration, embodiments will be described as including both a dynamic code and dynamic expiry information.

At 646, the merchant system 20 sends a response back through the network, which, for example, may involve sending the response to the acquirer (or other intermediary) 603. The response may include all or a portion of the following information: the digital token, the dynamic code and dynamic expiry information, data indicating the selection of bank and associated installment plan made by the buyer, and information associated with the transaction. The transaction information may include the total amount of the transaction, the currency being used for the transaction, and/or other information. The response may also include information indicating the acquirer identifier, a category code for the transaction, and information identifying the merchant, e.g., merchant name, merchant location, etc.

At 650, the acquirer (or intermediary) 603 invokes the payment management system 30 by performing, or issuing, a shadow balance check including the digital token and other information contained in the response sent from the merchant system 20.

At 654, the payment management system 30 performs a variety of operations. First, the payment management system 30 validates the acquirer identifier to confirm that the received information is from an authenticated source (654a). Acquirer identification may be confirmed, for example, as previously explained. Once the acquirer identifier has been validated, the payment management system may send an acknowledgment signal back to the acquirer 603.

Then, the payment token corresponding to the transaction is validated along with the dynamic code and dynamic expiry information encoded in the cryptogram sent with the payment token (654b). In one embodiment, this validation operation may be performed as follows. The payment management system 30 may generate the digital payment token and use an algorithm to generate the dynamic code and dynamic expiry information (e.g., CSC) along with a dynamic cryptogram. When these credentials are received again by the payment management system 30 (e.g., in connection with a transaction), the payment management system 30 may generate the cryptogram again and match it to the submitted one to validate its authenticity.

The validated payment token and digital code and expiry information are mapped to the bank and identifier of the buyer registered with the bank and the associated bank account.

After the digital token and dynamic code and expiry information are validated, the controller of the payment management system 30 may create a universally unique identifier (UUID) for the transaction (654c). The UUID may be created, for example, using any number of existing methods.

Next, the payment management system 30 may send notification of the request, for the installment plan selected by the buyer 10, to the bank selected by the buyer (654d). In one embodiment, the notification may include an identifier of the buyer 10 (who is an account holder at the bank), information designating the installment plan requested for the transaction, tenure, total amount of the transaction, category code, merchant name, merchant location, and the generated UUID. The notification may assist the bank in routing the request to the proper decision-maker, whether it be a software tool or personnel at the bank, by setting a flag in a predetermined field of the notification signal used to specify whether or not the notification corresponds to an installment plan request.

At 658, the payment management system 30 may send an acknowledgment to the acquirer (or other intermediary) 603 acknowledging that the information has been received and providing the UUID to the acquirer 603.

At 662, the acquirer 603 may optionally send the UUID to the merchant system 20.

At 666, the bank system 40 makes the decision as to whether to approve the installment plan for the transaction indicated in the notification from the payment management system 30. This decision-making process may include a system of the bank validating the buyer identifier registered at the bank and then optionally invoking a tool to authenticate the buyer and the bank account associated with the transaction. The bank system 40 may then perform a shadow balance check of the bank account of the buyer followed by a risk analysis. The risk analysis may take into consideration various factors including, for example, on a review of the buyer's credit, the amount of funds in the bank account and/or other requirements programmed into the bank system. Based on the results of the risk analysis, the bank system 40 may generate a decision approving or declining the installment plan. If approved, the bank system 40 then opens a loan account for the buyer 10 but will not debit the bank account of the buyer 10 pursuant to the now-approved installment plan.

A number of other actions may be taken by the bank system 40. These include pushing the funds for the transaction over a domestic real-time payment (RTP) network for fast clearing and settlement. For example, the acquirer 603 may submit clearing to the bank (that tokenizes the bank account to a PAN) for the full transaction amount with order details. This clearing may only be submitted when the transaction is not settled on the real time payment network. Settlement may take place in a business-as-usual (BAU) manner and the funds are moved from the bank 40 to the acquirer 603 or another designated account of the merchant. In some embodiments, the merchant may be another equipment manufacturer (OEM).

At 670, the bank system 40 may send a notification to the payment management system 30 indicating that the installment plan has been approved. The notification may include with an approval identifier and the UUID for the transaction. The approval identifier may be, for example, a reference number associated with approval of the installment plan as assigned by the bank system 40. The approval identifier may be used, for example, for future chargebacks or any queries that may arise during the period of the loan.

At 674, the payment management system 30 stores, in a database, the information from the bank system 40 corresponding to the approved installment plan and then sends a notification signal to the acquirer 603 indicating that the requested installment plan for the transaction has been approved (or if rejected, then notice is sent of the rejection).

At 678, the acquirer 603 provides a shadow balance response along with the approval identifier generated by the bank system 40 and the corresponding UUID.

At 682, the acquirer 603 then sends a message (with the approval identifier) to the merchant system 20 indicating that the installment plan has been approved (or declined if that is the case). The buyer 10 is then informed, for example, visually on the POS terminal or on the shopping cart application and the transaction is completed. Settlement for the transaction may include the bank system 40 sending full payment to the merchant, through the acquirer 603, for the goods or services purchased. The bank system 40 may then adjust the shadow balance of the buyer accordingly.

In one or more embodiments, the acquirer 603, payment service provider (PSP), or other intermediary within the network may use an application programming interface (API) to look up eligible installment plans and provide that information to the buyer 10, via the merchant system 20, during checkout. In one embodiment, the acquirer 603 or PSP may initiate the shadow balance check service previously described, which service may pass, for example, the following information from the acquirer 603 or PSP to the payment management system 20: payment token and the associated dynamic cryptogram, the installment plan selected by the buyer, total transaction amount, currency type, acquirer id, category code, and merchant information.

In performing the operations in FIG. 6, the payment management system 30 may perform security validation of the acquirer 603 based on the acquirer identifier issued by the system during registration. The payment management system 30 may validate the payment token and cryptogram as an addition measure of security and fraud prevention. The payment management system 30 may generate the UUID, which may be passed back in the acknowledgement to the acquirer 603, as yet another additional security measure for the transaction. The payment management system 30 may then map the payment token to the bank account of the buyer 10 and retrieve the unique identifier of the buyer 10 and bank account. The payment management system may then pass the following information (e.g., in the shadow balance API) to the bank system the UUID, bank account number, buyer identifier, merchant name, selected plan, transaction amount, and currency, MCC, acquirer identifier.

### Some Technological Solutions to Technological Problems and Innovations in the Field

One or more of the aforementioned embodiments implement security measures to manage the allocation of an installment plan that is based on the bank account of a buyer of goods or services. These security measures include: 1) having a payment management system assigning a unique identifier to each consumer financial institution (CFI) when registering; 2) having each CFI register their respective consumers with a respective CFI-provided unique consumer ID; 3) having each CFI generate a token PAN based on the PAN for each of their respective consumers; 4) having the CFI of the buyer use the token PAN to retrieve a dynamic expiry and a CSC from the merchant system; 5) having the payment management system assign each registered merchant with a unique merchant ID; and 6) having the payment management system, when processing a request for an installment plan from a buyer at a merchant, validate the unique identifier of the buyer's CFI, validate the CFI-provided unique consumer ID of the buyer, validate the token PAN, validate the dynamic expiry and CSC from the merchant system of the merchant; and validate the unique merchant ID of the merchant. The security measures may be implemented in real-time at the time of purchase, so that an immediate decision can be rendered at the point-of-sale terminal of the merchant or during use of an ecommerce application such as a shopping cart or other form of payment application used for making online purchases.

In some embodiments, the security measures may be implemented to allow the buyer to select a bank (or bank account) of his or her own choosing and/or to select which installment plan is best when the bank of the buyer offers multiple installment plans. The multiple installment plans may differ based on their terms and conditions, and the security measurements described herein may be used to allow the buyer to review the differing terms and conditions at the POS terminal or in an online shopping cart. The use of payment tokens, dynamic security information, and other protective measures ensure the real-time transaction is performed in a secure manner, while at the same time affording the buyer a convenient form of payment not heretofore available to consumers.

In some implementations, the security measures taken by embodiments described herein may be integrated into or otherwise used in cooperation with the code of a merchant system and the point-of-sale (POS) terminal of the retailer. This may be accomplished, for example, based on presenting the buyer with a POS terminal menu option to use an installment plan of a bank account to pay for the goods or services.

In addition, various embodiments may be effective in reducing or preventing fraud, by providing an alternative to making credit card purchases. For example, many bad actors use fake identification (e.g., ones stolen or fabricated) along with other stolen information to create a “synthetic ID.” Synthetic ID fraud accounts for a significant portion of all chargebacks to credit card companies, as much as 20% or more. In addition, bad actors have been able to open Buy Now, Pay Later accounts using stolen cards.

In these and other cases, the security measures implemented by one or more embodiments may prevent fraud and improve the speed of obtaining an approval decision on an installment-plan payment prior to when the purchase is attempted to be made, especially when information stored or generated on a credit card is used to input encrypted and/or dynamic information for processing by the payment management system. When it is determined by the payment management system is the inputted token PAN does not match the token PAN provided by the bank, the payment management system may decline the buyer's request to use an installment plan of a bank to make a purchase. Such improvements are not possible in the traditional case of using a credit card for purchase, because the buyer may not be notified of the fraud until weeks and sometimes months later when the synthetic ID or fraud is realized.

Additionally, in accordance with one or more embodiments, a system and method are provided which provides an installment experience to customers using bank accounts to pay at POS for in store and ecommerce purchases. One or more of these embodiments require no changes to the POS and no changes to the acquirer systems. The buyer may be prompted at merchant check out (for both ecommerce or instore) to pay in installments when using a bank account for payment. The transaction is secured using digital token and an associated cryptogram data when making purchases with installments.

Additionally, a buyer's bank may verify the identity of the buyer and the corresponding bank account and may process a loan account after proper validation, thus minimizing the synthetic ID fraud. Through these embodiments, the risk of synthetic ID fraud is minimal because the bank validates the buyer and the bank account prior to making a decision on whether to extend the loan in support of the installment plan.

Additionally, one or more embodiments may be delivered on a Domestic Real time payment network to clear and settle in real time, or may be used to clear and settle on any Card Scheme such as Mastercard. The solution provided may therefore be scheme-agnostic in accordance with one or more embodiments, thereby making the solution unique.

Additionally, the embodiments described herein may offer an installment plan marketplace for providing streamlined installment plans to shoppers. In some cases, Original Equipment manufacturer (OEMs) can provide installment plans, the merchant or a BNPL provider may provide installment plans, or the issuer can provide installment plans. This solution may cater to all plans provided by any third party. The solution is therefore unique in this additional way.

Also, there may be no processor required for the issuer and banks may be able to offer more payment choices to consumers, which may increase engagement with their own consumers (debtors). The embodiments may also be beneficial to merchants in terms of stabilizing, maintaining or even increasing business, especially during recessions. Merchants can also receive funds from installment-plan payments in real-time, since this solution can be settled on the real time payment network available in the country (e.g., TCH in US). For example, consumers can purchase higher-priced items without paying the full amount at the time of purchase.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The controllers, processors, logic, estimators, selectors, schedulers, prediction engines, and other signal generating and signal processing features of the embodiments described herein may be implemented in non-transitory logic which, for example, may include hardware, software, or both. When implemented at least partially in hardware, the controllers, processors, logic, estimators, selectors, schedulers, prediction engines, and other signal generating and signal processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controllers, processors, logic, estimators, selectors, schedulers, prediction engines, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments described herein.

Any reference in this specification to an “embodiment” means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. The features of any one embodiment may be combined with features of one or more other embodiments described herein to form additional embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although a number of illustrative embodiments are described herein, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art. The embodiments may be combined to form additional embodiments.

We claim:

1. A payment management system for use with a buyer, a merchant system, and a bank, the merchant system being configured to provide a good or service to the buyer and to generate a request of available banks, the bank being configured to establish a bank account for the buyer, to register with said payment management system, to provide a tokenized personal account number associated with the bank account to said payment management system, and to provide an available installment plan to said payment management system for the merchant system, the merchant system being additionally configured to provide the available installment plan to the buyer and to generate an installment plan selection including bank account information of the bank account for the buyer, said payment management system comprising:
a memory configured to store instructions; and
a controller configured to execute the instructions to:
register the bank;
receive the available installment plan from the bank;
receive the request of available banks from the merchant system;
validate the request;
provide the available installment plan to the merchant system based on a validation of the request;
receive the installment plan selection from the merchant system; and
provide the installment plan selection to the bank.

2. The payment management system of claim 1, wherein the installment plan selection includes a payment token associated with a primary account number (PAN) of the bank account.

3. The payment management system of claim 2, wherein the payment token is based on a card security code.

4. The payment management system of claim 2, wherein the installment plan selection includes dynamic expiry data indicating a period of validity of the payment token.

5. The payment management system of claim 4, wherein the controller is configured to execute the instructions to:
determine that at least one of the payment token or the dynamic expiry data is invalid; and
cause transmission of a signal to the merchant system declining the request.

6. The payment management system of claim 1, for further use with the bank being additionally configured to provide an installment plan approval based on the installment plan selection and the bank account, wherein the controller is configured to execute the instructions to additionally:
receive the installment plan approval; and
provide the installment plan approval to the merchant system.

7. A method of using a payment management system with a buyer, a merchant system, and a bank, the merchant system being configured to provide a good or service to the buyer and to generate a request of available banks, the bank being configured to establish a bank account for the buyer, to register with the payment management system, to provide a tokenized personal account number associated with the bank account to the payment management system, and to provide an available installment plan to the payment management system for the merchant system, the merchant system being additionally configured to provide the available installment plan to the buyer and to generate an installment plan selection including bank account information of the bank account for the buyer, said method comprising:
registering, via a controller configured to execute instructions stored on a memory, the bank;
receiving, via the controller, the available installment plan from the bank;
receiving, via the controller, the request of available banks from the merchant system;
validating, via the controller, the request;
providing, via the controller, the available installment plan to the merchant system based on a validation of the request;
receiving, via the controller, the installment plan selection from the merchant system; and
providing, via the controller, the installment plan selection to the bank.

8. The method of claim 7, wherein the installment plan selection includes a payment token associated with a primary account number (PAN) of the bank account.

9. The method of claim 8, wherein the payment token is based on a card security code.

10. The method of claim 8, wherein the installment plan selection includes dynamic expiry data indicating a period of validity of the payment token.

11. The method of claim 10, further comprising:
determining, via the controller, that at least one of the payment token or the dynamic expiry data is invalid; and
causing, via the controller, transmission of a signal to the merchant system declining the request.

12. The method of claim 7, for further use with the bank being additionally configured to provide an installment plan approval based on the installment plan selection and the bank account, said method further comprising:
receiving, via the controller, the installment plan approval; and
providing, via the controller, the installment plan approval to the merchant system.

13. A non-transitory, computer-readable media having computer-readable instructions stored thereon, the computer-readable instructions being capable of being read by a payment management system for use with a buyer, a merchant system, and a bank, the merchant system being configured to provide a good or service to the buyer and to generate a request of available banks, the bank being configured to establish a bank account for the buyer, to register with the payment management system, to provide a tokenized personal account number associated with the bank account to the payment management system, and to provide an available installment plan to the payment management system for the merchant system, the merchant system being additionally configured to provide the available installment plan to the buyer and to generate an installment plan selection including bank account information of the bank account for the buyer, wherein the computer-readable instructions are capable of instructing the payment management system to perform the method comprising:
registering, via a controller configured to execute instructions stored on a memory, the bank;
receiving, via the controller, the available installment plan from the bank;
receiving, via the controller, the request of available banks from the merchant system;
validating, via the controller, the request;
providing, via the controller, the available installment plan to the merchant system based on a validation of the request;
receiving, via the controller, the installment plan selection from the merchant system; and
providing, via the controller, the installment plan selection to the bank.

14. The non-transitory, computer-readable media of claim 13, wherein the installment plan selection includes a payment token associated with a primary account number (PAN) of the bank account.

15. The non-transitory, computer-readable media of claim 14, wherein the payment token is based on a card security code.

16. The non-transitory, computer-readable media of claim 14, wherein the installment plan selection includes dynamic expiry data indicating a period of validity of the payment token.

17. The non-transitory, computer-readable media of claim 16, wherein the computer-readable instructions are capable of instructing the payment management system to perform the method further comprising:
determining, via the controller, that at least one of the payment token or the dynamic expiry data is invalid; and
causing, via the controller, transmission of a signal to the merchant system declining the request.

18. The method of claim 13, for further use with the bank being additionally configured to provide an installment plan approval based on the installment plan selection and the bank account, wherein the computer-readable instructions are capable of instructing the payment management system to perform the method further comprising:
receiving, via the controller, the installment plan approval; and
providing, via the controller, the installment plan approval to the merchant system.
